(19) United States
(12) Patent Application Publication
(10) Pub. No.: US 2021/0237269 A1
(43) Pub. Date: Aug. 5, 2021

(54) INTERVENTION SYSTEMS AND METHODS FOR ROBOTIC PICKING SYSTEMS

(71) Applicant: Plus One Robotics, Inc., San Antonio, TX (US)

(72) Inventors: Paul Hvass, San Antonio, TX (US); Shaun Edwards, San Antonio, TX (US); Christopher T. Hardee, San Antonio, TX (US)

(73) Assignee: Plus One Robotics, Inc., San Antonio, TX (US)

(21) Appl. No.: 17/168,282

(22) Filed: Feb. 5, 2021

Related U.S. Application Data
(60) Provisional application No. 62/970,675, filed on Feb. 5, 2020.

(51) Int. Cl. B25J 9/16; B65G 47/90

(52) U.S. Cl. CPC B25J 9/1653; B65G 47/905; B25J 9/163; B25J 9/1674; B25J 9/161

(57) ABSTRACT

Described are approaches for assigning intervention requests from robots, robotic systems, and/or other smart systems to resources (e.g., human technicians, trained systems) in order to optimize system performance along a variety of different selection criteria specifying various performant dimensions, including, but not limited to improving system efficiency, reducing robot and/or robotics systems idle time, reducing technician idle time, improving triage outcomes, reducing data processing loads, maintaining client confidentiality that may be associated with one or more robotic picking systems.

### CROSS-REFERENCE TO RELATED APPLICATIONS

The present application claims priority to U.S. provisional application No. 62/970,675, filed Feb. 5, 2020, and entitled “INTERVENTION SYSTEMS AND METHODS FOR ROBOTIC PICKING SYSTEMS,” which is hereby incorporated herein in its entirety for all purposes.

### BACKGROUND

Robotic picking systems, for picking boxes, packages, envelopes and other items have improved significantly with the advent of automation technologies. However, despite advanced automation implementations, robotic systems often encounter edge cases and fail and require some human intervention to resume operations. Currently, human intervention is typically performed by human technicians who are on-site because a number of potential errors and/or breakdowns require a user to physically move items and/or diagnose the problem with direct visual inspection. Moreover, human intervention is generally considered undesirable because of the capital costs associated with such implementations. As a result, significant efforts have been made to eliminate human intervention from robotic picking system. For example, artificial intelligence (“AI”), and specifically machine learning (“ML”) implementations are often specifically designed to eliminate human intervention by various learning methodologies and picking rules. In turn, these automated implementations can increase the complexity of the required interventions, and require more highly trained intervention staff, remotely or otherwise, to intervene without significantly disrupting the automated processes. As a result, current robotic picking system implementations tend to optimize either for speed and automation (at the expense of accuracy and/or failure with regards to edge cases), or accuracy with regards to edge cases by enabling human intervention (at the expense of speed).

### SUMMARY

Systems and methods in accordance with various embodiments of the present disclosure may overcome one or more of the aforementioned and other deficiencies experienced in conventional approaches to managing resources. In particular, various embodiments describe approaches for assigning intervention requests from robots, robotic systems, and/or other smart systems to resources (e.g., human technicians, trained systems) in order to optimize system performance along a variety of different selection criteria specifying various performant dimensions, including, but not limited to improving system efficiency, reducing robot and/or robotics systems idle time, reducing technician idle time, improving triage outcomes, reducing data processing loads, maintaining client confidentiality, and the like.

Instructions for causing a computer system to assign requests (e.g., intervention requests, error codes, etc.) from robot and/or robotics systems and intervention resources (e.g., human technicians, autonomous systems, semi-autonomous systems, etc.) in accordance with the present disclosure may be embodied on a computer-readable medium. For example, in accordance with an embodiment, a backend system may maintain models and/or features for the models (including feature vectors) for a plurality of robots, robotic systems, and/or other smart systems, and/or intervention resources. The models and features can be determined using historic activity data associated with the robots, robotic systems, and/or other smart systems, and/or intervention resources. The backend system can utilize the models and features to assign intervention requests from robots, robotic systems, and/or other smart systems to intervention resources to optimize system performance along a variety of different selection criteria specifying various performant dimensions, including, but not limited to improving system efficiency, reducing robot and/or robotics systems idle time, reducing technician idle time, improving triage outcomes, reducing data processing loads, maintaining client confidentiality, and the like. The backend system can update the models and/or feature vectors upon the completion of an invention event, upon the completion of a task, upon completion of a number of invention events and/or tasks, in response to an event such as going offline or online of a robot and/or robotic system and/or intervention resource, with respect to an interval of time, or a combination thereof.

It should be noted that although the techniques described herein may be used for a wide variety of users and intervention requests, for clarity of presentation, examples of companies providing robotic picking systems will be used. The techniques described herein, however, are not limited to robotic picking systems, and the intervention request may be from entities that are not robots, robotic systems, and/or other smart systems.

Embodiments provide a variety of advantages. For example, in accordance with various embodiments, human technicians or other appropriate intervention resources may intervene from anywhere, including off-site locations without degradation in the quality of intervention and leading to an improvement in the behavior of the automated picking systems. Moreover, the present invention reduces time and costs associated with responding to intervention requests when compared to conventional intervention systems where human technicians or other such resources have to be physically present to respond to intervention requests, and in many situations, have to walk to or otherwise travel to these systems. Various other functions and advantages are described and suggested below as may be provided in accordance with the various embodiments.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates an example environment in which aspects of the various embodiments can be implemented;

FIG. 1B illustrates a network for providing intervention resources in accordance with an exemplary embodiment.

FIG. 2A illustrates an allocation system in accordance with an exemplary embodiment.

FIG. 2B illustrates example groupings of robots and/or robotic systems in accordance with various embodiments.

FIG. 3 illustrates a load balancing system in accordance with an exemplary embodiment.

FIG. 4 illustrates a modeling system in accordance with an exemplary embodiment.

FIG. 5 illustrates an example process for assigning requests to resources in accordance with various embodiments.

FIG. 6 illustrates an example process for assigning requests to resources in accordance with an alternate embodiment.

FIG. 7 illustrates components of a computing device that supports an embodiment of the present invention.

FIG. 8 illustrates an exemplary architecture of a system that supports an embodiment of the present invention.

FIG. 9 illustrates another exemplary architecture of a system that supports an embodiment of the present invention.

FIG. 10 illustrates components of a computer system that supports an embodiment of the present invention.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The present invention can be illustrated in various embodiments in addition to the embodiments described below. For instance, when the artificial intelligence (AI) within a smart camera system watching intersections to detect collisions between cars/bikes and pedestrians has low confidence in detecting such collisions, the AI may request human intervention. The AI may display short video and ask one or more humans whether a collision occurred or not. In another embodiment, automated path planners can create easy directions for humans to follow. The AI can check how easy the directions are by asking for humans to look at the directions and make any necessary changes. In an embodiment where manipulators try to attach two pieces together, the AI may request human intervention to assist in attaching the two pieces together. In another embodiment such as a speech to text system, the AI may request human intervention when it has difficulty understanding one or more words.

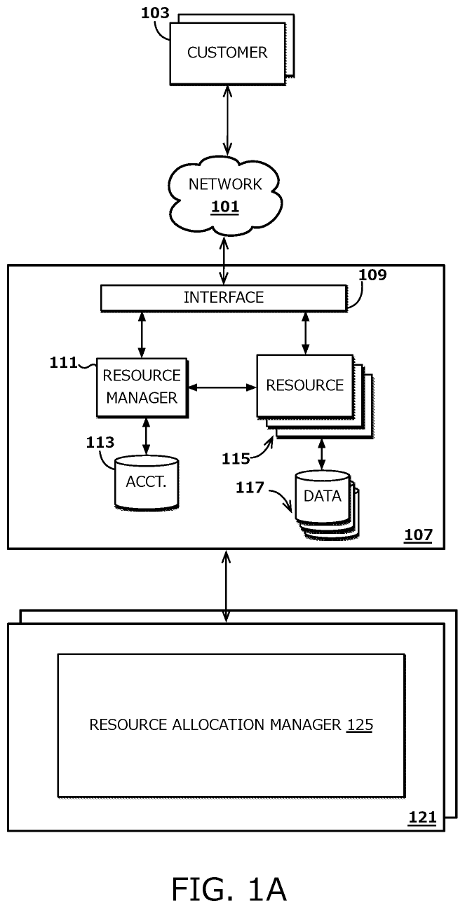

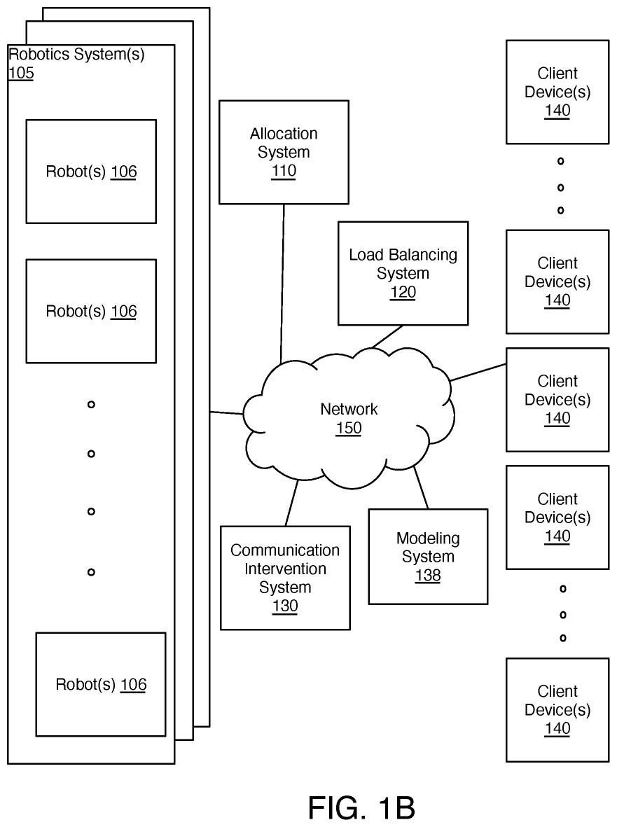

FIG. 1A illustrates an example environment in which aspects of the various embodiments can be implemented. In this example, a user can utilize a customer device 103 to communicate across at least one network 101 with a resource provider environment 107. The customer device 103 can include any appropriate electronic device operable to send and receive requests or other such information over an appropriate network and convey information back to a user of the device. Examples of such customer devices 103 include personal computers, tablet computers, smartphones, notebook computers, and the like. The user can include a person authorized to manage the aspects of the resource provider environment.

The network(s) 101 can include any appropriate network, including an intranet, the Internet, a cellular network, a local area network (LAN), or any other such network or combination, and communication over the network can be enabled via wired and/or wireless connections.

The resource provider environment 107 can provide robots and/or robotic picking systems for environments such as a mailroom, shipping facility, etc., for picking boxes, packages, envelopes, and other items, as well as support services for the robotic picking systems. The support services can include, for example, intervention services operable to assign intervention resources (e.g., human technicians, automated robotic systems, etc.) to respond to robot and/or robotic system errors. In certain embodiments, resource provider of environment 107 can be an intermediary between a customer (e.g., purchaser of a product) of a company and the company. The provider can, for example, assist the company by providing robots, robotic systems, and/or other smart systems and resources to manage such systems to support the company's mailrooms, shipping facilities, etc.

The resource provider environment 107 can include any appropriate components for generating intervention requests for robots, robotic systems, and/or other smart systems and assigning those requests to an appropriate intervention resource. It should be noted that although the techniques described herein may be used for a wide variety of users and requests, for clarity of presentation, examples of companies providing robots, robotic systems, and/or other smart systems will be used.

The resource provider environment 107 might include Web servers and/or application servers for receiving and processing requests then assigning those requests to an appropriate resource (e.g., a human technician, a machine technician, etc.) to assist with the request. While this example is discussed with respect to the internet, web services, and internet-based technology, it should be understood that aspects of the various embodiments can be used with any appropriate services available or offered over a network in an electronic environment.

In various embodiments, resource provider environment 107 may include various types of resources 115 that can be used to facilitate the processing of requests for robots, robotic systems, and/or other smart systems. The resources can include, for example, application servers operable to process instructions provided by a user or database servers operable to process data stored in one or more data stores 117 in response to a user request. The resources may be hosted on multiple server computers and/or distributed across multiple systems. Additionally, the components may be implemented using any number of different computers and/or systems. Thus, the components may be separated into multiple services and/or over multiple different systems to perform the functionality described herein. In some embodiments, at least a portion of the resources can be “virtual” resources supported by these and/or components.

In at least some embodiments, an application executing on customer device 103 that needs to access resources of the provider environment 107, for example, to initiate an instance of an intervention service, can submit a request that is received to interface layer 109 of the provider environment 107. The interface layer 109 can include application programming interfaces (APIs) or other exposed interfaces enabling a user to submit requests, such as Web service requests, to the provider environment 107. Interface layer 109 in this example can also include other components as well, such as at least one Web server, routing components, load balancers, and the like.

When a request to access a resource is received at the interface layer 109 in some embodiments, information for the request can be directed to resource manager 111 or other such systems, service, or component configured to manage user accounts and information, resource provisioning and usage, and other such aspects. Resource manager 111 can perform tasks such as communicating the request to a management component or other control component which can be used to manage one or more instances of an intervention service as well as other information for host machines, servers, or other such computing devices or assets in a network environment, authenticate an identity of the user submitting the request, as well as to determine whether that user has an existing account with the resource provider, where the account data may be stored in at least one data store 113 in the resource provider environment 107.

For example, the request can be used to instantiate an intervention service (e.g., a robot and/or robotic systems intervention service) on host machine 121. As will be described further herein, the intervention service can utilize resource allocation manager 125 to detect intervention requests from robots, robotic systems, and/or other smart systems and assign the intervention requests to an appropriate intervention resource. It should be noted that although host machine 121 is shown outside the provider environment, in accordance with various embodiments, one or more components of the invention service can be included in provider environment 107, while in other embodiments, some of the components may be included in the provider environment. It should be further noted that host machine 121 can include or at least be in communication with other components, for example, an allocation system, load balancing system, communication intervention system, etc., as described further in FIG. 1B.

FIG. 1B illustrates an exemplary embodiment of an intervention system according to an embodiment. The system includes one or more robotic picking systems 105, an allocation system 110, a load balancing system 120, communication intervention system 130, modeling system 138, client devices 140, and a network 150 over which the various systems communicate and interact. The various computing devices described herein are exemplary and for illustration purposes only. The system may be reorganized or consolidated, as understood by a person of ordinary skill in the art, to perform the same tasks on one or more other servers or computing devices without departing from the scope of the invention.

In one embodiment, the robotic picking system 105 may be comprised of one or more robots 106, computer-based robotic controller(s), robotic vision system(s), conveyor system(s), etc. Generally, the robotic picking system 105 is operative to retrieve or pick objects, e.g., packages, parts or the like, from a picking bin and place the objects onto an outfeed conveyor, e.g., an induction conveyor, for induction into a downstream process. The objects may be input to one or more bins randomly, e.g., by a supply or infeed conveyor or some other alternative system, for picking by robotic system 105. The objects may vary in size and shape. Also, the objects vary in orientation within the bin, e.g., due to the random nature of the delivery of the objects to the bin, due to the variations in the size and shape of the objects, and due to the fact that the objects may pile up on top of each other within the bin(s) in a random manner. The one or more robot(s) 106 may pick objects from bin and to deposit the objects onto an outfeed system such as a conveyor system, a flipper conveyor system etc., as provided by the robotic controller for further downstream processing. In accordance with an exemplary embodiment, the robot 106 may be comprised of a base, an arm, and an end effector, such grippers, suction cups, vacuum powered suction cups, etc. The various parts of the robot 106 may be connected by joint systems that would be familiar to persons of ordinary skill in the art and may provide various degrees of freedom.

The allocation system 110 matches one or more robots 106 and/or one or more robotics systems 105 with one or more client devices 140 (wherein one or more support technician may be represented by one or more client device 140) and/or other appropriate intervention resource. In accordance with an embodiment, the allocation system 110 ensures that each robot 106 has sufficient human technical support to enable the system to remain performant and/or to prevent delays that may be otherwise associated with human intervention systems. It should be noted that although embodiments are described with respect to client devices and associated human technicians, other resources may be utilized including, for example, autonomous robotic systems. That is, the functions of a human technician can be performed in hardware and software, such as by using a robot associated with a trained model trained for such functions.

In one embodiment, the allocation system may associate robots 106 and/or robotics systems 105 into one or more zones for efficient intervention handling. In an embodiment, a geographic area, building (e.g., warehouse), site, etc., can be shared by one or more organizations. Each organization can be associated with one or more zones, where a zone can include, for example, a picking zone, a packing zone, a shipping zone, etc. Each zone in certain embodiments can include a robot. For example, a picking zone can include a robot configured to move objects from one area to another area.

Resources may be assigned to particular zones. For example, a group of resources (e.g., technicians) may be associated with an organization. The organization may be associated with a set of zones. In this example, the group of resources may then be associated with robots in the set of zones. In various embodiments, resources may be associated with multiple organizations. In this situation, the resources can access robots in zones associated with these organizations.

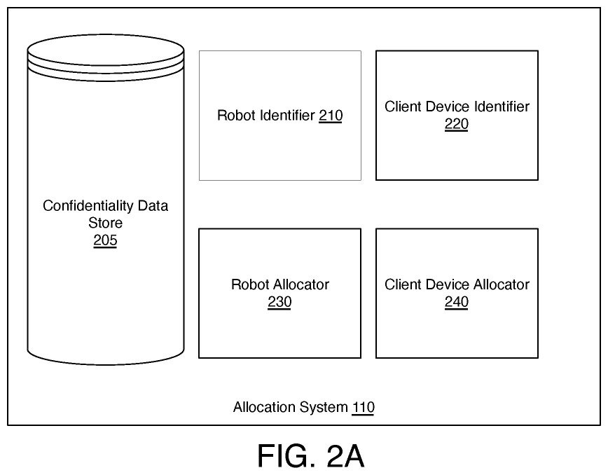

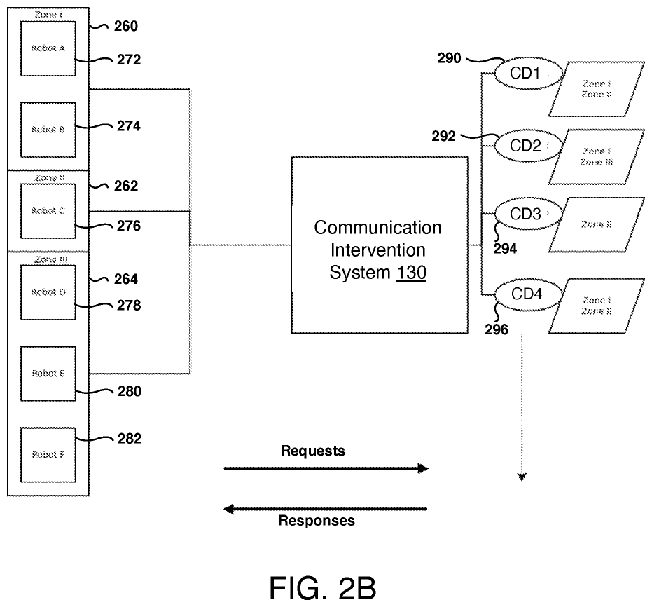

In an embodiment, the allocation system may associate client devices 140 into one or more zones for efficient intervention handling. In other embodiments, both the robots 106 and/or robotics systems 105, and client devices 140 may be placed in zones for efficient intervention handling. The allocation system 110 is described in greater detail in FIG. 2A, but in general, the allocation system 110 may group robots 106 and/or robotics systems 105 and/or client devices 140 in accordance with factors, including, but not limited to, system efficiency, lag time, client confidentiality (i.e. confidentiality that may be associated with one or more robots 106 and/or robotics systems 105), technician satisfaction, technician performance, technician response rates, or a combination thereof. Factors as used herein may also be referred to as performance metrics (e.g., robot performance metrics, responder performance metrics).

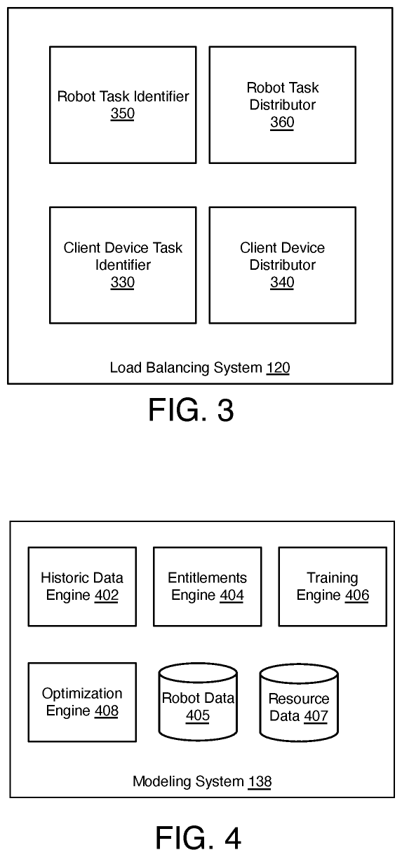

The load balancing system 120 may reassign tasks and/or groupings selected by the allocation system 110 in order to optimize system performance along a variety of different performant dimensions specified by selection criteria, including, but not limited to improving system efficiency, reducing robot and/or robotics systems idle time, reducing technician idle time, improving triage outcomes, reducing data processing loads, maintaining client confidentiality, in accordance with a cost structure, etc. A task in various embodiments can include a picking task, a separation task, a packing task, a detection task, a moving task, etc. The load balancing system 120 is described in greater detail below in reference to FIG. 3.

The communication intervention system 130 translates error messages that may originate from a robot 106 and/or a robotics system 105 into graphical user interfaces that permit human technicians to quickly and efficiently triage and resolve the errors. Communication intervention system 130 may also generate an intervention request based on the error message. Generally, robots 106 and/or robotics systems 105 may be autonomous in performing many of their assigned tasks. However, the robots 106 and/or robotics systems 105 may encounter tasks which they cannot perform—in those circumstances the robots 106 and/or robotics systems 105 may generate one or more error messages. For example, robots 106 and/or robotics systems 105 may encounter packages that are overlapping, packages that cannot be differentiated by a robot vision system, packages that cannot be singulated by available singulation systems, etc. In these instances and others, the robots 106 may generate an error message and corresponding intervention request. The allocation system 110 and the load balancing system 120 described herein may assign and route the error message to a client device 140 in order to obtain further assistance. The communication intervention system 130 may translate the error message into one or more graphical user interfaces that permit technicians to quickly and easily diagnose the problem and resolve it. For example, the communication intervention system 130 may classify the error code generated by the robot 106 and/or the robotics system 105 and may classify it as, for example, a detection error, a pick error, a singulation error, an induction error etc. The communication intervention system 130 may generate different user interfaces based on the types of errors that are identified and/or classified. For example, if an error code is associated with identifying pick points, then the communication intervention system 130 may obtain imaging data (such as, for example, two dimensional and/or three-dimensional data of a bin containing objects) and may present the imaging data to one or more client devices 140 (or other intervention resource) in such a way that the user (or intervention resource) may respond to the request. For example, a user may select pick points directly on the graphical user interface that is presented to one or more client devices 140. A user may simply select one or more pick point in a user interface and the communication intervention system 130 may thereafter translate the user input into coordinates that may be used by the robots 106 and/or robotics systems 105 to complete the pick point selection task. The selected pick points may also be used to train models and/or generate features for the models to automatically make such a selection. A graphical user interface is described herein as being provided to a client device 140, however, other types of communication may be provided without departing from the scope of the invention, including, but not limited to: written material such as code, instruction snippets, one or more two and/or three-dimensional images, video, audio/oral instructions, etc. In each instance the communication intervention system 130 may translate the user input into instructions that are readable by robots 106 and/or robotics systems 105.

Modeling system 138 may generate models and/or features for the models of robots 106 and/or robotics systems 105 and/or users of client devices 140 (or other intervention resources). The models and features can correspond to an individual measurable property, characteristic, or performance metric of a robot and/or robotic system and/or intervention resource. For example, the properties, characteristics, or performance metrics can correspond to system efficiency, lag time, client confidentiality, resource performance, resource response rates, etc. The features in various embodiments can be described by a feature vector.

The models and features can be used to optimize system performance. For example, models of robots, robotic systems, and/or other smart systems and/or intervention resources can be used to optimally assign intervention requests to an appropriate resource.

A model and feature(s) of a robot and or robotic system can be generated using historic activity data for that robot. The historic activity data can include image data that includes representations of one or more tasks completed by a robot, accuracy data for one or more tasks, timing data for one or more tasks, idle time data, active time data, etc. The activity data can be obtained from robot log records, organization records, and the like. Activity data for each robot can be used to train a plurality of models and generate a plurality of features of the models for respective robots. In an example, a trained model or features for the trained model can be used to predict a likelihood of successfully completing a task, such as picking up a box. In another example, a trained model or features for the trained model can be used to generate an accuracy score for completing a task, such as identifying pickable boxes.

A model of an intervention resource can include a trained model of a human technician or other appropriate resource. The model or features of the model can be trained using historic activity data associated with the human technician. The historic activity data can include, for example, response time for handling various tasks, accuracy in handling various tasks, and the like, idle time data, active time data, and the like. The activity data can be obtained from a user profile, organization records, etc. Activity data for each human technician can be used to train a plurality of models and/or generate a plurality of feature vectors for respective human technicians. In an example, a trained model or features of the model can be used to predict a likelihood of successfully resolving an intervention event, an amount of time to resolve an intervention event, an accuracy score for resolving an intervention event, a likelihood of having to ask for assistance in resolving an intervention event, etc. Modeling system 138 is described in greater detail below in reference to FIG. 4.

When using human intervention resources, client device(s) 140 permit users to receive error data that is translated by the communication intervention system 130 and submit instructions for resolving the errors. Client devices 140 may include, generally, a computer or computing device including functionality for communicating (e.g., remotely) over a network 150. Data may be collected from client devices 140, and data requests may be initiated from each client device 140. Client device(s) 140 may be a server, a desktop computer, a laptop computer, personal digital assistant (PDA), a smart phone or other cellular or mobile phone, or mobile gaming device, among other suitable computing devices. Client devices 140 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each client device 140 may be an electronic device including hardware, software, or embedded logic components or a combination of two or more such components and capable of carrying out the appropriate functions implemented or supported by the client device 140. For example and without limitation, a client device 140 may be a desktop computer system, a notebook computer system, a netbook computer system, a handheld electronic device, or a mobile telephone. The present disclosure contemplates any client device 140. A client device 140 may enable a network user at the client device 140 to access the network 150. A client device 140 may enable its user to communicate with other users at other client devices 140.

A client device 140 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A client device 140 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the client device 140 one or more Hyper Text Markup Language (HTML) files responsive to the HTTP request. The client device 140 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The client device 140 may also include an application that is loaded onto the client device 140. The client device 140 obtains data from the network 150 and displays it to the user within the application interface.

Exemplary client devices are illustrated in some of the subsequent figures provided herein. This disclosure contemplates any suitable number of client devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1B (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1B, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2A illustrates an exemplary embodiment of the allocation system 110. The allocation system may be comprised of a confidentiality data store 205, robot identifier 210, client device identifier 220, robot allocator 230, and client device allocator 240. The allocation system 110 matches one or more robots 106 and/or one or more robotics systems 105 with one or more client devices 140 (wherein one or more support technician may be represented by one or more client device 140). It should be noted that although client devices are described, any resource may be used in accordance with embodiments described herein. The resources can include, for example, automated robotic systems.

In one embodiment, the robot identifier 210 and the robot allocator 230 group robots 106 (hereinafter also referred to as “robotic picking devices”) and/or robotics systems 105 into one or more groupings (hereinafter also referred to as “zones”). In one embodiment, the robot identifier 210 obtains an inventory of robots 106 within one or more robotics systems 105. The inventory of robots may be used to group robots 106 into one or more categories in accordance with grouping criteria. For example, the inventory robots may be grouped based on an association with one or more robotics system 105, types of tasks performed, confidentiality obligations associated with one or more robots 106 and/or robotic systems 105, frequency with which error codes are generated, types of error codes typically or commonly generated, etc.

The client device identifier 220 and the client device allocator 240 group client devices 140 into one or more groupings (hereinafter also referred to as “zones”). In one embodiment, the client device identifier 220 obtains an inventory of client devices 140 that may be available to assist one or more robots 106 and/or robotic systems 105. In one embodiment, the client device identifier 220 may identify all client devices 140 that may be capable of providing intervention. In other embodiments, the client device identifier 220 identifies accounts and/or user permissions that are provisioned or enabled to provide intervention. The client device identifier may further identify client devices 140 associated with those logins/accounts that are available and online to assist robots 106 and/or robotic systems 105.

The client device allocator 240 may assign client devices 140 to groupings or zones based on a variety of factors, including one or more of, but not limited to: confidentiality/access control permissions, availability to intervene, length of queue, ability/expertise to provide affective intervention, available computing resources and network throughput, etc.

The confidentiality data store 205 may be accessed by the robot allocator 230 and/or the client device allocator 240 to make grouping decisions based on permissions related to confidentiality. In one embodiment, the robot allocator 230 and/or the client device allocator 240 may access and/or reference the confidentiality data store 205 and may group all users/client devices 140 and/or robots 106 and/or robotics systems 105 that have the same access permissions into one zone or grouping. For example, confidentiality data store 205 can include confidentiality parameters may be comprised of information about whether certain robots and/or certain robotics systems may interact with certain intervention resources (e.g., technicians) who may be associated with one or more client devices. For example, certain robots and/or robotics systems may be associated with a client, vendor, and/or organization, who may only want to share error codes/types with certain other technicians who may be associated with one or more client devices. In some instances, some robots and/or robotics systems may require technicians to have certain clearances or qualifications. In certain instances, some robot and/or robotics system clients/vendors may require that technicians who support their robots/systems may not support, for example, competitors' robots/system. Instances of these rules may be provided in the confidentiality parameters.

FIG. 2B illustrates one exemplary way to group various robots 106 and/or robotics systems 105 (illustrated as Robot A . . . F) and client devices (illustrated as CD1 . . . 4). In this example, an inventory of robots can be obtained. The inventory of robots can include robot 272, robot 274, robot 276, robot 278, robot 280, and robot 282. The inventory of robots can be grouped into one of zone 260, zone 262, and zone 264 in accordance with grouping criteria or operation data. The grouping criteria can specify groupings based on an association with one or more robotics systems, types of tasks performed, confidentiality obligations associated with one or more robots and/or robotic systems, frequency with which error codes are generated, types of error codes typically or commonly generated, etc. For example, based on the types of tasks performed, zone 260 includes robot 272 and robot 274, zone 262 includes robot 276, and zone 264 includes robot 278, robot 280, and robot 282. It should be noted that groupings illustrated herein are merely example groupings, and in accordance with various embodiments systems described herein can—and are designed to scale—to hundreds or thousands of robots 106 and/or client devices 140. It should be further noted that the zones can be associated with one or more organizations. For example, zone 260 and 262 can be associated with a first organization and zone 264 can be associated with a second organization. In various embodiments, each of zone 260, zone 262, and zone 264 can be associated with the same organization.

An inventory of client devices can also be obtained. The inventory of client devices can specify client devices that may be available to assist one or more of robot 272, robot 274, robot 276, robot 278, robot 280, and robot 282. The client devices can be assigned to a robot based on a plurality of factors, including, for example, confidentiality/access control permissions, availability to intervene, length of queue, ability/expertise to provide affective intervention, available computing resources and network throughput, etc. In an example, the client devices may be grouped with robots based on access permissions. As illustrated in FIG. 2B, client device 290 is assigned to zone 260 and zone 262; client device 292 is assigned to zone 260 and zone 264; client device 294 is assigned to zone 262, and client device 296 is assigned to zone 260 and zone 262.

Communication intervention system 130 can receive an intervention request from robot 272. The intervention request can be associated with selection criteria from an organization. In an embodiment, selection criteria can also be referred to as and specify performant dimensions, goals, requirements, preferences, metrics or other information indicating performance goals. The selection criteria may apply to a robot and/or robotic systems or an intervention resource such as one of the client devices.

Communication intervention system 130 can translate the intervention request which can be provided to one of the client devices. For example, communication system may classify the intervention request generated by robot 272 and may classify it as, for example, a detection error. The translated intervention request can be assigned to one of client device 290, client device 292, or client device 294 based on the selection criteria. Specifically, the intervention request can be assigned to a client device based on availability to intervene, length of queue, ability/expertise to provide affective intervention, available computing resources and network throughput, etc. This can include, for example, analyzing a queue of intervention requests for each client device to determine how many requests each associated human is handling while providing intervention for the robots, the time required to resolve each request, the number of requests that each human is performing, and the complexity of each request that the humans are receiving.

In another example, a user profile associated with each of the client devices may also be used to assign the invention request to an appropriate intervention resource, such as one of the client devices. For example, for each user profile (hereinafter also referred to as “resource profile” or “intervention resource profile”), a model or features for that model that specify attributes of an intervention resource can be determined. As described, the models and feature(s) can correspond to an individual measurable property or characteristic of a robot and/or robotic system and/or intervention resource. The property or characteristic represented using models and features can be determined using activity data associated with the robots, robotic systems, and/or other smart systems and/or intervention resources. The features in various embodiments can be described by a feature vector. Based on the selection criteria and features associated with the client devices, a client device can be selected and the intervention request assigned. For example, as will be described further herein, and in accordance with an embodiment, performant dimensions specified by selection criteria can be compared to features of resources stored in a database. A selection score can be generated for each comparison. The resources can be ranked based on respective selection scores. For example, the resources can be ranked from highest to lowest. A list of client devices can be generated and a client device selected based on selection scores. Thereafter, an appropriate response can be provided to robot 272, including, for example, resolving the intervention event, seeking additional assistance, etc.

In various embodiments, devices may be selected to intervene in accordance with arbitration policies. An arbitration policy can specify rules for selecting client devices or other resources. The rules may specify how to group client devices, ordering or tiers of client devices, resource scheduling, resource forecasting, etc.

Groupings or sets of client devices can include pairs of client devices or other groupings of client devices. In an example, a pair of client devices can include a primary resource and a secondary resource. The primary resource can include, for example, a lead resource, such as a resource having more experience than a secondary resource. In this example, in the situation the primary resource is selected, the secondary resource can also be selected. Accordingly, the secondary resource can be instructed to accompany the primary resource to learn how the primary resource responds to the intervention request. Similarly, this can include the situation where the secondary resource responds to the request and the primary resource observes and provides necessary assistance to the secondary resource.

Selecting client devices in accordance with tiers can include assigning client devices to different response tiers, where individual tiers can be associated with threshold response times. In this example, a list or grouping of client devices capable of responding to an intervention request can be determined. The list can be an ordered list of devices. For example, the list of client devices may include, for example, a number of highest scoring client devices or other grouping of client devices. The client devices can be ranked and associated with tiers or levels. For example, a highest scoring client device can be associated with a first tier or first level, the second highest scoring client device can be associated with a second tier or second level, and so on. Other assignment methods known in the art are contemplated in accordance with the embodiments described herein. In this example, an intervention request can be assigned to a queue associated with a client device in tier 1. The intervention request may be offered to the client device associated with tier 1 for a period of time. For instance, the client device may have a minute to indicate they are available to respond to the intervention request. In the situation the client fails to act on the intervention request, such as by indicating or otherwise beginning to respond to the intervention request, the request can be offered to a different client device, such as the client device associated with tier 2.

Arbitration policies may further specify selecting and assigning resources in accordance with resource scheduling, resource forecasting, etc., as described in FIG. 4.

FIG. 3 illustrates an exemplary embodiment of the load balancing system 120. The load balancing system 120 can function to ensure that the tasks being performed by the robots, and the tasks which the humans are providing assistance for are distributed in accordance with desired parameters or selection criteria. The load balancing system 120 may be comprised of a client device task identifier 330, a client device task distributor 340, a robot task identifier 350, and a robot task distributor 360. The various systems and sub-systems described herein reassign tasks and/or groupings selected by the allocation system 110 in order to optimize system performance along a variety of different performant dimensions, including, but not limited to improving system efficiency, reducing robot and/or robotics systems idle time, reducing technician idle time, improving triage outcomes, reducing data processing loads, maintaining client confidentiality, etc.

The robot task identifier 350 can determine the tasks which the robots are performing. More specifically, the robot task identifier 350 can determine the number of tasks that each robot is performing, the type of tasks which the robots are performing, the time required to complete each task, etc. From such variables, the robot task identifier 350 can identify if some robots are performing more tasks than other robots or are performing tasks that they are no longer equipped to handle. In addition, robot task identifier 350 can identify robots recently offline due to, e.g., component issues, errors, etc., or scheduled to be offline due to, for example, maintenance, performance issues, etc. Additionally, the robot task identifier 350 can determine if one or more of the robots are assigned more tasks which take much longer to complete than the other robots. Accordingly, the robot task identifier 350 can determine if the task distribution among the robots is uneven or disproportionate. As a result, the robot task identifier 350 can inform the robot task distributor 360 that the tasks between the robots should be redistributed. The robot task distributer 360 can redistribute the tasks among the robots to ensure that the tasks are evenly distributed and/or activate additional robots and redistribute the tasks among the robots. Moreover, the robot task distributer 360 can ensure that the number of tasks each robot is working on, the time spent on each task, and the number of requests for human intervention among the robots are evenly distributed.

In an embodiment, the client device task identifier 330 can identify how many tasks or requests that each human or intervention resource is handling while providing intervention for the robots. The client device task identifier 330 can determine the time required for each tasks, the number of requests that each human is performing, and the complexity of each request that the humans are receiving. Similar to the robot task identifier 350, the client device task identifier 330 can determine if any of these conditions among the humans are uneven. As a result, the client device task identifier 330 can inform the client device task distributor 340 to redistribute the requests among the humans should the requests that the humans are each performing are currently distributed unevenly. The client device task distributor 340 can redistribute the requests to other humans so that each human is handling a similar number of tasks, and/or that the response times to handle the tasks are substantially similar. In various embodiments, a user profile associated with each of the client devices may also be used to redistribute the requests. For example, for each user profile (hereinafter also referred to as “resource profile” or “intervention resource profile”), a model and features for the model that specify attributes of an intervention resource can be determined. Based on the selection criteria and features for the client devices, a client device can be selected and the intervention request assigned.

Further, the client device task distributor 340 can also reassign humans to different zones to work with different robots to ensure that the requests that the humans are each receiving are evenly distributed.

FIG. 4 illustrates an exemplary embodiment of modeling system 138. Modeling system 138 is operable to generate models and feature(s) for the model of robots, robotic systems, and/or other smart systems and/or users of client devices. The models and features of those models can be used to ensure that intervention requests are assigned to resources in accordance with desired parameters or selection criteria. For example, the requests can be assigned in order to optimize system performance along a variety of different performant dimensions, including, but not limited to improving system efficiency, reducing robot and/or robotics systems idle time, reducing technician idle time, improving triage outcomes, reducing data processing loads, maintaining client confidentiality, etc. Modeling system 138 may include historic data engine 402, entitlements engine 404, training engine 406, and optimization engine 408.

Historic data engine 402 obtains activity data associated with intervention resources (e.g., human technicians) and activity data associated with robots, robotic systems, and/or other smart systems. In an example, the activity data for the robots, robotic systems, and/or other smart systems can include image data (e.g., still images and/or video data) that includes representations of one or more tasks completed by a robot. For example, the image data can include a representation of a robot determining pick points for an object. In another example, the image data can include a representation of a robot picking up an object and moving it from one location to another location. In various embodiment, the activity data can include log records for the robots. The log records can include, for example, log files specifying actions taken by the robots, results of the actions, time stamps, etc. The log records can be analyzed to determine accuracy data for one or more tasks, timing data for one or more tasks, idle time data, active time data, etc. The activity data associated with the robots, robotic systems, and/or other smart systems can be stored in robot data store 405.

The historic activity data for the intervention resources can include, for example, a log of time stamps and actions taken, the log specifying, e.g., when an intervention request is received and completed. The log can be analyzed to determine response time for handling various tasks, accuracy in handling various tasks, an amount of idle time of an intervention resource, an amount of active time for an intervention resource, etc. The activity data can be obtained from a user profile, organization records, etc., and stored in resource data store 407.

It should be noted that although the data stores are shown as separate data stores, data from the data stores can be maintained across fewer or additional data stores. The data stores can be maintained locally or remote the components described herein. For example, a third-party can maintain some of the data stores or all of the data stores, among other such options.

Entitlements engine 404 obtains selection criteria from an organization. In an embodiment, selection criteria can also be referred to as and specify performant dimensions, goals, requirements, preferences, metrics or other information indicating performance goals. The selection criteria can be received in the form of instructions such as a configuration file or other information indicating the selection criteria. The selection criteria may apply to a robot and/or robotic systems and/or an intervention resource. In the situation the selection criteria apply to a robot and/or robotic systems, the selection criteria may specify, or include thresholds for robot and/or robotics system efficiency, robot and/or robotics systems idle time thresholds, data processing load thresholds, throughput thresholds, etc. The selection criteria may specify an order of importance for individual selection criterion. In the situation the selection criteria apply to an intervention resource, the selection criteria may specify or include thresholds for resource idle time, resource completion rate, resource average completion time for various intervention requests, etc.

Entitlements engine 404 can analyze the selection criteria to identify selection criteria components. For example, in the situation the selection criteria apply to a robot and/or robotic systems, a first component may include a requirement for confidentiality, a second component may include a requirement for throughput, and a third component may include a requirement for accuracy. In the situation the selection criteria apply to an intervention resource, a first component may indicate an experience level, a second component may indicate a response time, and a third component may indicate a completion rate.

The selection criteria components in certain embodiments may be weighted. For example, a configuration file may indicate a level of importance for the selection criteria, which is described further below with respect to optimization engine 408. In short, the selection criteria can be associated with weighting assignments. The weighting assignments can be used to apply a weight value (e.g., an importance value or preference) to each of the selection criteria components. For example, weighting assignments may weight throughput more heavily than accuracy. The selection criteria components can be dynamically weighted. For example, the selection criteria components can be weighted based on the type of intervention request, a particular requesting robot and or robotic system, etc. In an example, an organization may specify that when a particular type of intervention request is generated, e.g., a picking error, accuracy is weighted greater than throughput.

The configuration file in various embodiments may indicate an order of selection components to be satisfied when assigning an intervention request to a resource. In this example, individual selection components may be associated with a threshold. In an embodiment, an intervention resource that best satisfies the selection components can be selected. For example, a first selection component can be associated with a first threshold and a second selection component can be associated with a second threshold. Specifically, the first selection component can correspond with an experience level and the second selection component can correspond with a response time threshold. In the situation the first threshold is not satisfied, the system determines whether the second threshold is satisfied. That is, if it is determined none of the intervention resources satisfy the threshold experience level, a determination can be made whether an intervention resource satisfies the second threshold. In the situation the second threshold is satisfied, the intervention resource satisfying the threshold is selected. In the situation the second threshold is not satisfied, a default intervention resource can be selected or some other process can be initiated. If more than one intervention resource satisfies a threshold, the intervention resource associated with a better score may be selected. In certain embodiments, multiple resources may be selected to, for example, facilitate the training of resources, resource scheduling, resource forecasting, etc. Training resources may include, for example, assigning an intervention request to two or more resources, where at least one resource is configured to train the other resources in responding to the intervention request.

Resource scheduling may include, for example, scheduling intervention requests to certain resources so that other resources are available to handle particular intervention requests. In this example, the best fit resource may not be selected to ensure that resource is available for other requests.

Similar to resource scheduling, resource forecasting can include, for example, predicting future intervention requests and potential resources to respond to those requests, and reserving those resources for the predicted intervention requests. For example, the robots, robotic systems, and/or other smart systems can utilize prediction models to predict the likelihood of future intervention requests based on upcoming objects to be processed and/or selection criteria. For instance, the prediction models can be used to predict types of intervention requests and expected times for the intervention requests. Based on predicted types of intervention requests and expected times, resources can be reserved for those expected times to respond to the requests.

The selection criteria can dynamically change. For example, for a particular period of time, the selection criteria may include throughput and accuracy. In this example, during the period of time, throughput may be preferred and weighted more than accuracy. Further, there may be no criteria as to confidentiality and thus, no or reduced limitations on intervention resources. During a different time period, or for particular objects processed by the robots, accuracy may be weighted over other selection criteria such as throughput. In this example, importance is placed on correctly processing an object. Further to this example, the selection criteria may limit the intervention resources allowed to intervene. For example, intervention resources at a threshold experience level with particular permissions may be utilized while others that do not satisfy the threshold experience level and permissions are not utilized.

Training engine 406 is operable to build models and feature(s) for the models that specify performant dimensions of robots, robotic systems, and/or other smart systems and intervention resources. The models or feature(s) can be generated using historic activity data from data store 405 and data store 407. For example, a trained model can determine one of a number of features from the historic activity data. With respect to robots, robotic systems, and/or other smart systems, a trained model can be used to generate features that can be used to predict a likelihood of successfully completing a task, such as picking up a box. In this example, the trained model can include a value for a feature representing the picking skill level of the robot. The feature can be compared to an appropriate threshold to determine whether the picking skill level of the robot is sufficient. In another example, a trained model can be used to generate features that can be used to predict an accuracy score for completing a task, such as identifying pickable boxes. In this example, the trained model can include a value for a feature representing the accuracy level of the robot. The feature can be compared to an appropriate threshold to determine whether the accuracy level of the robot is sufficient. The features in certain embodiments can be combined to generate a feature vector representing various features of the robot.

With respect to an intervention resource, a trained model can be used to generate features that can be used to predict a likelihood of successfully resolving an intervention event. In this example, the trained model can include a value for a feature representing the likelihood of successfully resolving an intervention event. The feature can be compared to an appropriate threshold to determine whether the resource will resolve the intervention event. In another example, a trained model can be used to generate features that can be used to predict an amount of time to resolve an intervention event. In yet another example, a trained model can be used to generate features to predict an accuracy score for resolving an intervention event. In yet another example, a trained model can be used to generate features to predict a likelihood of having to ask for assistance in resolving an intervention event. In at least these examples, the trained models may represent values for features associated with the intervention resource and the features can be compared to an appropriate threshold to determine which intervention resource for selection.

Optimization engine 408 is configured to update models and/or features. For example, the models and/or features may be updated upon the completion of an invention event, upon the completion of a task, upon completion of a number of invention events and/or tasks, in response to an event such as going offline or online of a robot and/or robotic system and/or intervention resource, with respect to an interval of time, or a combination thereof. In an embodiment, updating models and/or features can include analyzing activity data and updating the numerical features that represent or correspond to selection criteria for robots, robotic systems, and/or other smart systems and/or intervention resources.

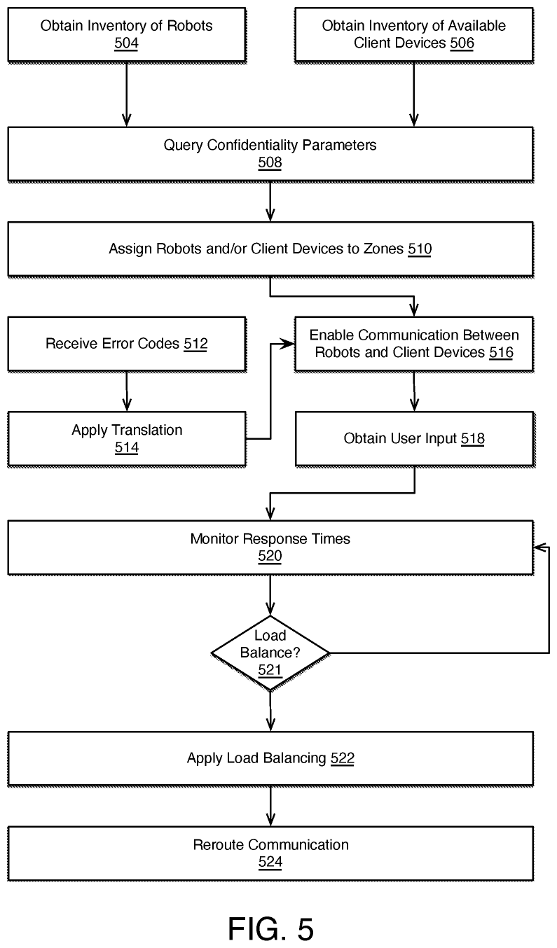

FIG. 5 illustrates an exemplary process enabling real-time or near-real-time resource intervention in autonomous or semi-autonomous robotics systems. In one embodiment of the invention, the process begins by obtaining 504 an inventory of robots and/or robotics systems.

In one embodiment, an inventory of the various robots and/or robotics systems may be obtained 504 by obtaining an inventory log listing one or more robots and/or robotics systems. In another embodiment, items in the inventory log may be identified as inventory items if they are online and/or carrying out a task.

An inventory of available intervention resources (e.g., client devices) may be obtained 506. Client devices as used herein may refer, by proxy, humans may be assigned to each one or more client devices. In one embodiment, an inventory of available and online client devices may be obtained based on active user logins in a network connected system like the one described above in reference to FIG. 1B.

In one embodiment, the process may continue by querying 508 confidentiality parameters associated with one or more robots, robotic systems, and/or other smart systems and/or one or more client devices. The confidentiality parameters may be comprised of information about whether certain robots and/or certain robotics systems may interact with certain intervention resources (e.g., technicians) who may be associated with one or more client devices. For context, certain robots and/or robotics systems may be associated with a client, vendor, and/or organization, who may only want to share error codes/types with certain other technicians who may be associated with one or more client devices. In some instances, some robots and/or robotics systems may require technicians to have certain clearances or qualifications. In certain instances, some robot and/or robotics system clients/vendors may require that technicians who support their robots/systems may not support, for example, competitors' robots/system. Instances of these rules may be provided in the confidentiality parameters.

The process described herein queries 508 confidentiality permissions and assigns 510 robots and/or client devices to zones.

The assignment may be made based on a variety of different factors and/or decision dimensions. For example, assignments 510 may be based on confidentiality permissions, types of tasks performed, frequency with which error codes are generated, types of error codes typically or commonly generated, whether technicians are trained and/or equipped to provide meaningful intervention outcomes, etc. In one embodiment, the client devices (i.e. technicians) may provide assistance to robots/robotics systems that are assigned to the same zones as the technicians.

Meanwhile, (i.e., concurrently and/or before/after) the robots/robotics systems may be performing the various tasks that are assigned to them. If the robots/robotics systems are unable to complete a task, they may generate an error code or intervention request. In some embodiments, error codes may be generated in accordance with a library of known errors/error codes. In other embodiment, error codes may be generated based on the type of error detected (i.e. errors in the vision system, picking system, singulation system, etc.). In one embodiment, once error codes are received 512 the process may apply 514 a translation that enables technicians at one or more client devices to triage the error associated with the error code and potentially resolve it. A variety of different translations may be applied without departing from the scope of the invention, including for example, providing a graphical user interface illustrating two and/or three-dimensional views of a picking bin. In one embodiment, a user may be prompted to select, for example, a pick point to aid the robot/robotic system in making a pick. In other embodiments, the translation 514 may be specifically designed to permit a technician to supply an input directly into the user interface that is provided to him or her. In one embodiment, a technician, via his or her client device, may be enabled to select a pick point directly on the graphic user interface that may be provided to the user. As such, the process enables 516 communication between robots/robotic systems and client devices in a manner that permits remote interventions. If user input is provided by a technician, that input may be obtained 518 and may be passed to the relevant robot and/or robotic system, where the robot may act based on the obtained 518 user input.

Steps 520, 522, and 524 enable the process to optimize performance along one or more dimensions/factors, including, but not limited to improving system efficiency, reducing robot and/or robotics systems idle time, reducing technician idle time, improving triage outcomes, reducing data processing loads, maintaining client confidentiality, etc. These various dimensions/factors may be optimized for by first monitoring 520 response times. In one embodiment, the process may monitor 520 the number of requests and the response times of those requests to determine if load balancing is necessitated.

With respect to both the humans and the robots, a determination is made 521 whether to load balance. For example, the number of requests and the response times for those requests can be compared to appropriate thresholds. For example, the response times for individual humans can be compared to thresholds and the response times for robots can be compared to thresholds. This can include, for example, determining a total response time for the requests for each human responder and each robot.

In the situation it is determined load balancing is not needed, the process continues to monitor response times. In the situation it is determined that the response time for one or more human responders or robot satisfies the threshold, load balancing is applied 522 to the communication requests. That is, the system can redistribute the requests based on its monitoring of the communication requests and response times. In this way, the process can ensure that one or more of the humans are not unduly burned with requests that take much longer to provide a response, or more requests than the other humans. Specifically, the process can ensure that a queue of requests for each resource satisfies a queue threshold, where the queue threshold can represent a threshold for a total amount of time to respond to requests in a queue, a level of difficulty for requests in a queue, etc. In an example, the system can estimate a total amount of time to respond to requests for each resource. The total amount of time can be compared to a threshold amount of time. In the situation the total amount of time is greater than the threshold amount of time, the system can redistribute the requests for that resource. In the situation the total amount of time is not greater than the threshold amount of time, the system can redistribute requests to the resource. Similarly, the process can ensure that one or more of the robots are not overly burdened with more tasks that require more human intervention than the other robots. Specifically, the process can ensure that a queue of tasks for each robot satisfies a queue threshold, where the queue threshold can represent a threshold for a total amount of time to complete to tasks in a queue, a level of difficulty for tasks in a queue, etc.

Multiple humans can be asked for the same help simultaneously. As a result, an arbitration system can be in place to pick which humans' or resources help can be passed onto the robots. In an example, intervention requests can be assigned to resources in accordance with arbitration policies. The arbitration policies can be used to select one or more resources to respond to the requests. In certain embodiments, resources may be selected in accordance with resource groupings, tiers of resources, etc. Selecting resources in accordance with resource groupings can include, for example, selected pairs of resources (e.g., a primary and secondary resource) or selecting other groupings of resources. Selecting resources in accordance with tiers of resources can include assigning resources to different response tiers, where individual tiers can be associated with threshold response times. In this example, an intervention request may be offered to a resource associated with, e.g., tier 1, for at least a period of time. In the situation the resource fails to act on the intervention request, such as by indicating or otherwise beginning to respond to the intervention request, the request can be offered to a different resource, such as the resource associated with tier 2. Arbitration policies may further specify selecting and assigning resources in accordance with resource scheduling, resource forecasting, etc., as described herein. In various embodiments, resources can be selected and assigned in accordance with a combination of approaches described herein.

At step 524, communication requests are rerouted as necessary. The requests can be rerouted in order to optimize system performance along a variety of different selection criteria specifying various performant dimensions, including, but not limited to improving system efficiency, reducing robot and/or robotics systems idle time, reducing technician idle time, improving triage outcomes, reducing data processing loads, maintaining client confidentiality, and the like. Additionally, the requests can be rerouted in accordance with the arbitration policies. Accordingly, assigning and load balancing requests can be based on selection criteria and arbitration policies. Further, the process can reroute the tasks among the robots to ensure that the requests for human intervention are rerouted as well. As the tasks are rerouted to other robots, the humans assigned to the zones of the other robots can also receive requests for intervention to assist with tasks from those other robots accordingly.

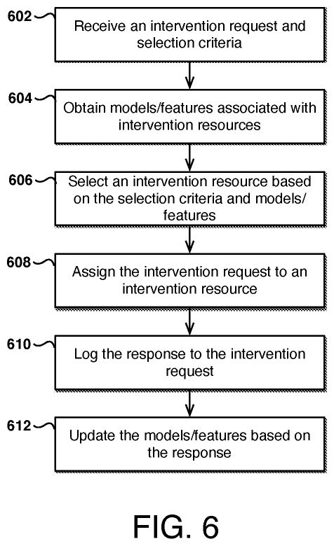

FIG. 6 illustrates an example process for selecting and assigning intervention requests to intervention resources (e.g., human responder) in accordance with various embodiments. In this example, an intervention request can be received 602 from a robot and/or robotics system to an assignment queue to be assigned to an intervention resource. The intervention request can be generated based on a type of error detected (e.g., an error in a robots vision system, picking system, etc.) The intervention request can be associated with selection criteria from an organization. In an embodiment, selection criteria can also be referred to as and specify performant dimensions, goals, requirements, preferences, metrics or other information indicating performance goals. The selection criteria can be associated with an organization and may apply to a robot and/or robotic systems or an intervention resource. In the situation the selection criteria apply to a robot and/or robotic systems, the selection criteria may specify, or include thresholds for robot and/or robotics system efficiency, robot and/or robotics systems idle time thresholds, data processing load thresholds, throughput thresholds, an order of importance for individual selection criterion. In the situation the selection criteria apply to an intervention resource, the selection criteria may specify or include thresholds for resource idle time, resource completion rate, resource average completion time for various intervention requests, etc.

A plurality of models can be obtained 604. The plurality of models can be associated with intervention resource accounts and robots, robotic systems, and/or other smart systems. An intervention resource account can be a user account associated with a human technician. The plurality of models can correspond to feature vectors that specify one or more features of an intervention resource and a robot and/or robotics system. For example, with respect to robots, robotic systems, and/or other smart systems, a trained model can be used to predict a likelihood of successfully completing a task, such as picking up a box. In this example, the trained model can include a value for a feature representing the picking skill level of the robot. In another example, a trained model can be used to generate an accuracy score for completing a task, such as identifying pickable boxes. In this example, the trained model can include a value for a feature representing the accuracy level of the robot. The features in certain embodiments can be combined to generate a feature vector representing various features of the robot. With respect to intervention resources, a trained model can be used to predict a likelihood of successfully resolving an intervention event. In this example, the trained model can include a value for a feature representing the likelihood of successfully resolving an intervention event. In another example, a trained model can be used to predict an amount of time to resolve an intervention event. In yet another example, a trained model can be used to predict an accuracy score for resolving an intervention event. In yet another example, a trained model can be used to predict a likelihood of having to ask for assistance in resolving an intervention event. In at least these examples, the trained models may represent values for features associated with the intervention resource.

Based on the selection criteria and feature vectors (or models) for a plurality of intervention resources, an intervention resource can be selected 606 and the intervention request assigned 608. For example, performant dimensions specified by the selection criteria can be compared to feature vectors of intervention resources stored in a database. In an embodiment, individual feature scores of the features can be an average score of the feature scores, a weighted average of the feature scores, a normalized average of the feature scores, etc. A selection score can be generated for each comparison based on a similarity of the feature vectors using an appropriate comparison technique known in the art. For example, at least one ranking technique can process the features or a feature vector to determine a set of selection scores or other such scores associated with selection criteria. A selection score can, for example, quantify the degree to which an intervention request matches a particular intervention resource. The intervention resources can be ranked based on respective selection scores. For example, the resources can be ranked from highest to lowest.

A list of client devices associated with the ranked intervention resources can be generated and a client device can be selected based on the selection scores. An appropriate response can be provided to the intervention request, including, for example, resolving the intervention event, seeking additional assistance, etc. Actions taken to respond to the intervention request can logged 610 to a log file, activity data store, or other appropriate location. The models and/or feature vectors may be updated 612 in accordance with embodiments described herein upon the completion of an invention event, upon the completion of a task, upon completion of a number of invention events and/or tasks, in response to an event such as going offline or online of a robot and/or robotic system and/or intervention resource, with respect to an interval of time, or a combination thereof.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

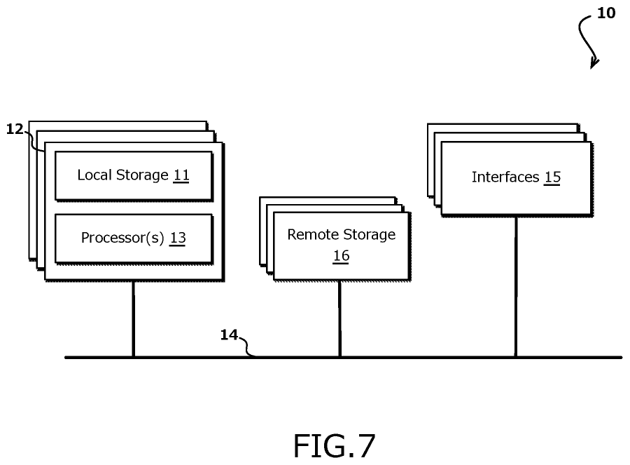

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memory storage, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

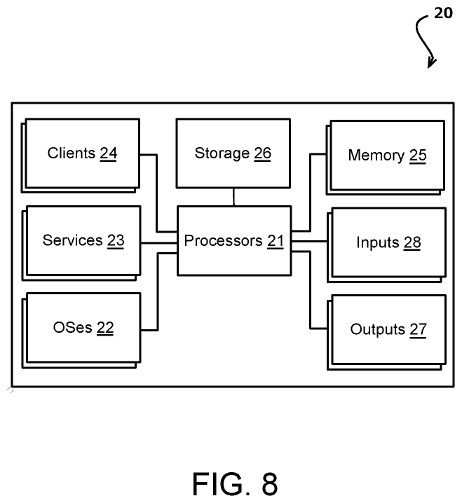

In some embodiments, systems may be implemented on a standalone computing system. Referring now to FIG. 8, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memory storage, or electrical storage device for storage of data in digital form (such as those described above, referring to FIG. 7). Examples of storage devices 26 include flash memory, magnetic hard drive, CD-ROM, and/or the like.

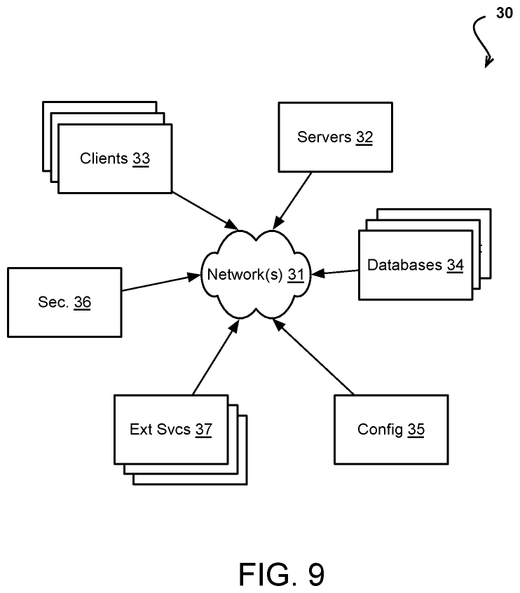

In some embodiments, systems may be implemented on a distributed computing network, such as one having any number of clients and/or servers. Referring now to FIG. 9, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 8. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

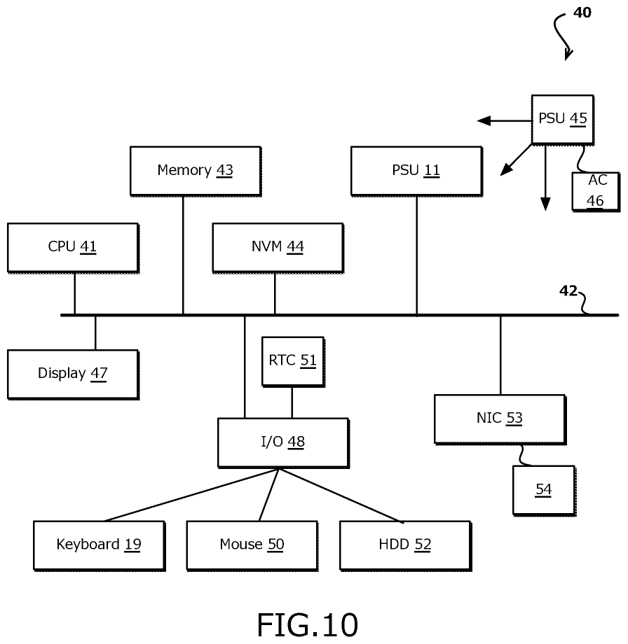

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system, comprising:
at least one processor; and
memory including instructions that, when executed by the at least one processor, enables the computing system to:
obtain a list of a plurality of robotic picking devices, individual robotic picking devices associated with selection criteria for selecting a responder to process an intervention event;
obtain a list of a plurality of responders, individual responders associated with a responder profile, respective responder profiles specifying responder performance metrics;
receive by a robotic picking device a request for intervention for a type of intervention event;
identify confidentiality parameters and a set of selection criteria associated with the robotic picking device;
use the confidentiality parameters to identify a group of responders authorized to access the robotic picking device;
obtain responder performance metrics associated with responders of the group of responders from respective responder profiles;
evaluate a responder selection function on the responder performance metrics to generate a plurality of selection scores, the responder selection function configured to optimize for at least one selection criterion;
rank the group of responders based on the plurality of selection scores; and
generate assignment information, the assignment information identifying a responder from the group of responders to intervene on behalf of the robotic picking device.

2. The computing system of claim 1, wherein the instructions, when executed by the at least one processor, further enables the computing system to:
obtain access rights associated with the plurality of responders; and
compare the confidentiality parameters with the access rights to determine the group of responders having access rights to the robotic picking device.

3. The computing system of claim 1, wherein the instructions, when executed by the at least one processor, further enables the computing system to:
obtain computer-readable information specifying an error message for the type of intervention event;
analyze the computer-readable information to generate classification information for the error message; and
use the classification information to generate a graphical user interface including a representation of the error message.

4. The computing system of claim 3, wherein the error message includes one of a detection error, a pick error, a singulation error, or an induction error.

5. The computing system of claim 1, wherein the set of selection criteria includes weighted selection criteria, and wherein the instructions, when executed by the at least one processor, further enables the computing system to:
apply at least one adjustment to the responder selection function based on the weighted selection criteria.

6. The computing system of claim 1, wherein the instructions, when executed by the at least one processor, further enables the computing system to:
obtain grouping criteria associated with the plurality of robotic picking devices; and
organize the plurality of robotic picking devices into one or more zones based on the grouping criteria.

7. The computing system of claim 6, wherein the grouping criteria includes confidentiality obligations associated with the plurality of robotic picking devices, frequency with which error codes are generated by the plurality of robotic picking devices, or types of error codes generated by the plurality of robotic picking devices.

8. The computing system of claim 1, wherein the set of selection criteria specifies at least one of a throughput threshold, an accuracy threshold, or a confidence threshold.

9. The computing system of claim 1, wherein the responder performance metrics specify at least one of access control permissions, availability to intervene, length of queue, expertise level, intervention delay, intervention accuracy, intervention throughput, or intervention cost.

10. The computing system of claim 1, wherein a responder includes a person or a machine.

11. The computing system of claim 1, wherein the instructions, when executed by the at least one processor, further enables the computing system to:
generate a first selection score for a first customer performance metric for each responder in the group of responders;
generate a second selection score for a second customer performance metric for each responder in the group of responders; and
weight first selection scores and second selection scores based on the at least one customer performance metric.

12. The computing system of claim 1, wherein the instructions, when executed by the at least one processor, further enables the computing system to:
generate the assignment information based on one of an availability of the plurality of responders or historical assignment information for the plurality of responders.

13. The computing system of claim 1, wherein the instructions, when executed by the at least one processor, further enables the computing system to:
detect performance of the request by the responder; and
update responder performance metrics associated with the responder.

14. A computer-implemented method, comprising:
obtaining a list of a plurality of robotic picking devices, individual robotic picking devices associated with selection criteria for selecting a responder to process an intervention event;
obtaining a list of a plurality of responders, individual responders associated with a responder profile, respective responder profiles specifying responder performance metrics;
receiving by a robotic picking device a request for intervention for a type of intervention event;
identifying confidentiality parameters and a set of selection criteria associated with the robotic picking device;
using the confidentiality parameters to identify a group of responders authorized to access the robotic picking device;
obtaining responder performance metrics associated with responders of the group of responders;
evaluating a responder selection function on the responder performance metrics to generate a plurality of selection scores, the responder selection function configured to optimize for at least one selection criterion;
ranking the group of responders based on the plurality of selection scores; and
generating assignment information, the assignment information identifying a responder from the group of responders to intervene on behalf of the robotic picking device.

15. The computer-implemented method of claim 14, further comprising:
obtaining access rights associated with the plurality of responders; and
comparing the confidentiality parameters with the access rights to determine the group of responders having access rights to the robotic picking device.

16. The computer-implemented method of claim 14, further comprising:
obtaining computer-readable information specifying an error message for the type of intervention event;
analyzing the computer-readable information to generate classification information for the error message; and
using the classification information to generate a graphical user interface including a representation of the error message.

17. A non-transitory computer readable storage medium storing instructions that, when executed by at least one processor of a computing system, causes the computing system to:
obtain a list of a plurality of robotic picking devices, individual robotic picking devices associated with selection criteria for selecting a responder to process an intervention event;
obtain a list of a plurality of responders, individual responders associated with a responder profile, respective responder profiles specifying responder performance metrics;
receive by a robotic picking device a request for intervention for a type of intervention event;
identify confidentiality parameters and a set of selection criteria associated with the robotic picking device;
use the confidentiality parameters to identify a group of responders authorized to access the robotic picking device;
obtain responder performance metrics associated with responders of the group of responders;
evaluate a responder selection function on the responder performance metrics to generate a plurality of selection scores, the responder selection function configured to optimize for at least one selection criterion;
rank the group of responders based on the plurality of selection scores; and
generate assignment information, the assignment information identifying a responder from the group of responders to intervene on behalf of the robotic picking device.

18. The non-transitory computer readable storage medium of claim 17, wherein the instructions, when executed by the at least one processor, further enables the computing system to:
obtain access rights associated with the plurality of responders; and
compare the confidentiality parameters with the access rights to determine the group of responders having access rights to the robotic picking device.

19. The non-transitory computer readable storage medium of claim 17, wherein the instructions, when executed by the at least one processor, further enables the computing system to:
obtain computer-readable information specifying an error message for the type of intervention event;
analyze the computer-readable information to generate classification information for the error message; and
use the classification information to generate a graphical user interface including a representation of the error message.

20. The non-transitory computer readable storage medium of claim 17, wherein the instructions, when executed by the at least one processor, further enables the computing system to:
generate a first selection score for a first customer performance metric for each responder in the group of responders;
generate a second selection score for a second customer performance metric for each responder in the group of responders; and
weight first selection scores and second selection scores based on the at least one customer performance metric.
